(19) United States
(12) Patent Application Publication
(10) Pub. No.: US 2010/0034636 A1
(43) Pub. Date: Feb. 11, 2010

(54) Stabilizing Apparatus For Vertical Axis Wind Turbine

(76) Inventor: Kuei-Sheng Tsou, Hsinchu (TW)

Correspondence Address: LIN & ASSOCIATES INTELLECTUAL PROPERTY, INC., P.O. BOX 2339, SARATOGA, CA, 95070-0339, US

(21) Appl. No.: 12/189,778

(22) Filed: Aug. 11, 2008

(51) Int. Cl. F03D 7/06

(52) U.S. Cl. 415/4.2

(57) ABSTRACT

A stabilizing apparatus is provided, applicable to all kinds of vertical axis wind turbine (VAWT), including a plurality of ball units and at least a guiding unit. The guiding unit has a circular cross-section and forms a ring-shaped housing space inside for housing the ball units. The inner wall of the bottom of the ring-shaped housing space inside the guiding unit forms a ring-shaped guiding surface. The ring-shaped guiding surface extends from the center of the apparatus towards the brink of the circumference of the apparatus. The straight line connecting the edge of the inner circle and the edge of the outer circle of the ring-shaped guiding surface forms an angle of 0-45° to the horizon surface. When the present invention is installed with the wind turbine rotor of a VAWT and rotates with the wind turbine rotor synchronously, the ball units move outward along the ring-shaped guiding surfaces because of the centripetal force; hence, the rotational inertia of rotor system increases as the rotor rotation speed is increased by wind so that the wind turbine rotor can start with a lower starting torque and spin more stably.

### FIELD OF THE INVENTION

The present invention generally relates to a stabilizing apparatus for vertical axis wind turbine (VAWT), and more specifically to an apparatus for automatically changing rotational inertia of the wind turbine rotor to reduce the vibration and shaking of wind turbine rotor caused by turbulence during rotation, and to achieve low wind speed start and to stabilize and maintain the rotor rotation speed.

### BACKGROUND OF THE INVENTION

Vertical axis wind turbine (VAWT) uses the wind turbine rotor with multiple blades and an axis perpendicular to the ground. The main advantage of VAWT is that VAWT can extract energy of wind streaming from any directions; therefore, VAWT performs better in turbulence than horizontal axis wind turbine (HAWT).

Wind turbine rotor is one of the most important components of VAWT. The blade geometry of the wind turbine rotor will directly affect the power efficiency of VAWT. The wind turbine rotor with higher rotational inertia is better at reducing the shaking and vibration of the wind turbine rotor caused by the turbulence while requiring a higher wind speed and torque for starting and activating. On the other hand, the wind turbine rotor with lower rotational inertia is easily affected by turbulence on the rotation stability while the advantage is easy to activate.

The theoretic value of the equivalent rotational inertia is

$$I = \frac{1}{2} {MR}^{2}$$

or I=MR², where M is the mass of wind turbine rotor, and R is the radius of the wind turbine rotor.

Therefore, to increase the rotational inertia of the wind turbine rotor can be achieved by increasing the mass or the radius of the wind turbine rotor. However, VAWT needs a higher start-up wind speed for the wind turbine rotor with bigger mass. And, to increase the radius of wind turbine rotor will cause constraint to VAWT products design for applications. Therefore, it is imperative to devise a stabilizing apparatus to be used with the original design and structure of wind turbine rotor so as to automatically change the rotational inertia of the wind turbine rotor to achieve the objectives of requiring a lower start-up wind speed, and maintaining and stabilizing the rotor rotation speed.

### SUMMARY OF THE INVENTION

The primary objective of the present invention is to provide a stabilizing apparatus for vertical axis wind turbine (VAWT). The apparatus is installed on the same axis as the wind turbine rotor of the VAWT, and the two rotate synchronously around the same axis. The main feature of the apparatus is that the rotational inertia of the apparatus can be changed by rotor speed. The apparatus includes a plurality of ball units. The ball units can move from the center outward to the circumference of the apparatus due to the centripetal force caused by the rotation of the apparatus. Therefore, when the apparatus starts rotated by the wind, the distance between the ball units and the center of the rotation axis increases; hence, the rotational inertia of the apparatus is increased. Because the apparatus and the wind turbine rotor can be integrated together and rotate synchronously, the overall rotational inertia of the wind turbine rotor is also changed accordingly. When the rotation speed of wind turbine rotor is increasing, the rotational inertia of rotor system is also increasing until the ball units are all on the brink of the circumference of the apparatus to obtain a maximum rotational inertia of rotor system, so as to achieve the objectives of reducing the vibration and shaking of wind turbine rotor caused by turbulence during rotation, and maintaining and stabilizing the rotor rotation speed.

Another objective of the present invention is to provide a stabilizing apparatus having a wide range of applications. Because the apparatus of the present invention is capable to automatically change the rotational inertia without changing the original design and structure of the wind turbine rotor of the VAWT when the wind turbine rotor rotates, the apparatus of the present invention is easier to be integrated with the current wind turbine rotor of VAWT.

Yet another objective of the present invention is to provide a stabilizing apparatus to be installed at the top, bottom, or the shaft body between the top and the bottom of wind turbine rotor. The present invention can also be installed and integrated between two wind turbine rotors when a plurality of wind turbine rotors are stacked so as to obtain higher torque.

To achieve the above objectives, the present invention provides a stabilizing apparatus for VAWT, including a plurality of ball units and at least a guiding unit. The ball units are balls with proper weight, such as metal balls. The guiding unit has a circular cross-section and has a ring-shaped housing space formed inside the guiding unit. The ball units are housed inside the ring-shaped housing space of the guiding unit. The inner wall of the bottom of the ring-shaped housing space inside the guiding unit forms a ring-shaped guiding surface. The ring-shaped guiding surface extends from the center of the apparatus towards the brink of the circumference of the apparatus. The straight line connecting the edge of the inner circle and the edge of the outer circle of the ring-shaped guiding surface forms an angle of 0-45° to the horizon surface. When the apparatus starts rotated with wind turbine rotor by wind, the ball units are closer to the center initially; therefore, rotor system having a smaller rotational inertia and requires a lower wind speed to start the rotation. When the rotation speed increases, the ball units are moved by the centripetal force so that the rotational inertia also increases and the wind turbine rotor can rotate more stably.

The foregoing and other objectives, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a top view of the first embodiment according to the invention;

FIG. 2 shows a cross-sectional view of the structure shown in FIG. 1;

FIG. 3 shows a schematic view of the present invention in actual application with a type of wind turbine rotor of VAWT;

FIG. 4 shows a schematic view of the present invention in actual application with another type of wind turbine rotor of VAWT;

FIG. 5 shows a lateral cross-sectional view of the second embodiment of the present invention; and

FIG. 6 shows a vertical cross-sectional view of the second embodiment of the present invention.

### DETAILED DESCRIPTION OF THE PREFERRED EMBODIMENTS

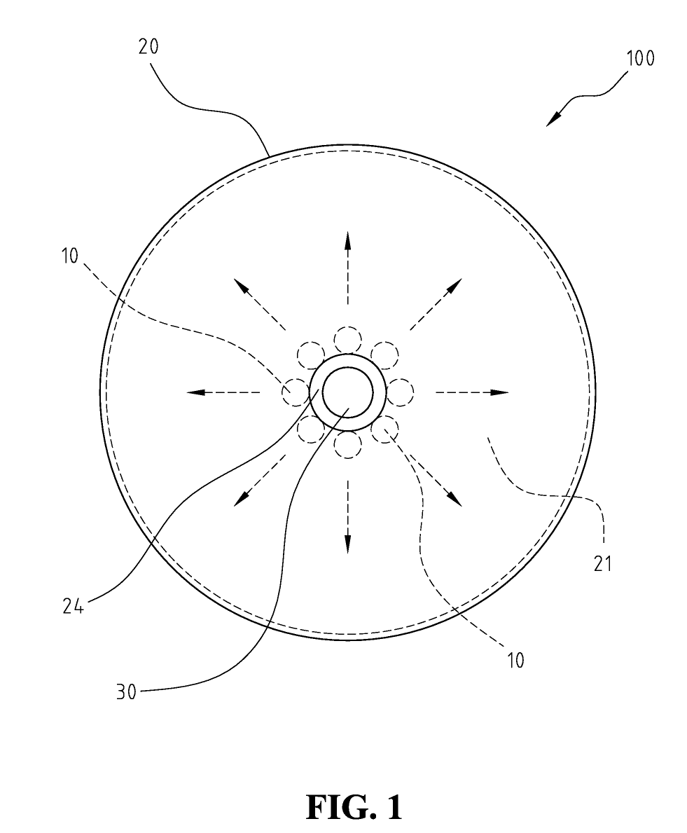

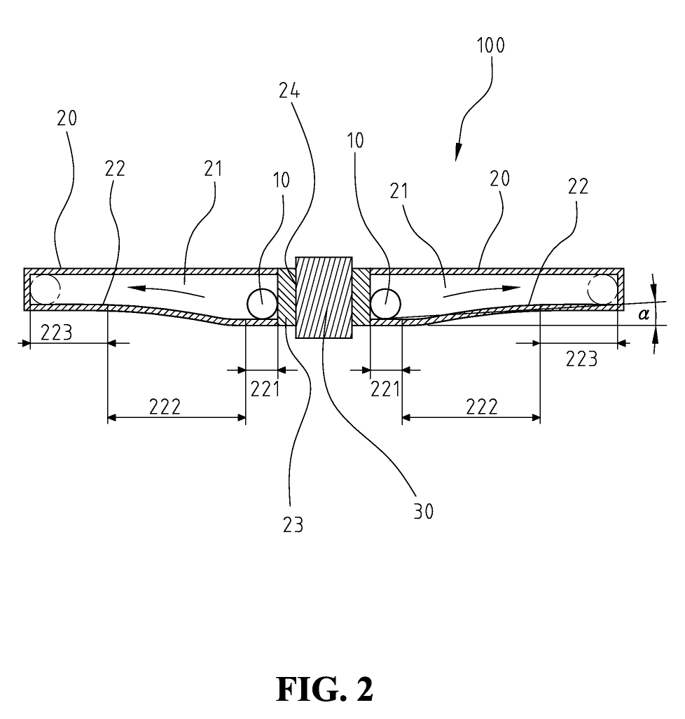

FIGS. 1 and 2 show a top-view and a cross-sectional view of a stabilizing apparatus of the present invention respectively. The apparatus of the present invention is to be installed with the wind turbine rotor of the VAWT and shares the same axis as the wind turbine rotor. Apparatus 100 includes a plurality of ball units 10 and at least a guiding unit 20. Guiding unit 20 has a circular cross-section and has a ring-shaped housing space 21 formed inside. The inner wall of the bottom of ring-shaped housing space 21 inside guiding unit 20 forms a ring-shaped guiding surface 22. Ring-shaped guiding surface 22 extends from the center of the apparatus towards the brink of the circumference of the apparatus. The straight line connecting the edge of the inner circle and the edge of the outer circle of ring-shaped guiding surface 22 forms an angle α of 0-45° to the horizon surface. Ball unit 10 is a ball with a proper weight. In the present embodiment, ball unit 10 can be, but not limited to, a metal ball. Ball units 10 are housed inside ring-shaped housing space 21. When apparatus 100 starts to rotate because the wind turbine rotor is rotated by wind, ball units 10 will roll along ring-shaped guiding surface 22 from close to the center towards the brink of the circumference of apparatus 100 because of the centripetal force. The movement distance of ball units 10 depends on the magnitude of the centripetal force and the angle α of ring-shaped guiding surface 22. The movement distance of ball units 10 will change the rotational inertia of apparatus 100 and the overall wind turbine rotor to achieve the objectives of lower wind speed start and activation as well as stabilizing rotation of the wind turbine rotor, including stabilizing and maintaining the rotation speed of the wind turbine rotor and stabilizing the possible vibration caused by turbulence.

The following describes the components of the present invention in details.

Guiding unit 20 is a disk with a certain height and has a circular lateral cross-section. Guiding unit 20 has a circular cross-section and has a ring-shaped housing space 21 formed inside. The inner wall of the bottom of ring-shaped housing space 21 inside guiding unit 20 forms a ring-shaped guiding surface 22. Ring-shaped guiding surface 22 extends from the center of apparatus 100 towards the brink of the circumference of apparatus 100. The straight line connecting the edge of the inner circle and the edge of the outer circle of ring-shaped guiding surface 22 forms an angle α of 0-45° to the horizon surface. However, ring-shaped guiding surface 22 can be of a plurality of different forms. The following describes some of the embodiments of ring-shaped guiding surface 22 used in the present invention. Firstly, ring-shaped guiding surface 22 can be a ring-shaped flat surface. In this case, the angle α is 0°. Secondly, ring-shaped guiding surface 22 has a shape of an upside-down cone with the vertical cross-section view of two symmetrical slant lines. In this case, the angle between the slant lines and the horizon surface is 0-45°. Thirdly, ring-shaped guiding surface 22 is an upside-down cone with a vertical cross-sectional view of two symmetrical curves monotonically increasing from the center edge towards the outer edge. Therefore, the curve can be of any shape, such as arc. Fourthly, the vertical cross-sectional view of ring-shaped guiding surface 22 consists of a plurality of segments, with each segment not necessarily the same. However, the cross-section of each segment must be of symmetrical straight lines, slant lines or curves. The present embodiment uses the aforementioned fourth form. As shown in FIG. 2, ring-shaped guiding surface 22 includes a first ring-shaped segment 221, a second ring-shaped segment 222 and a third ring-shaped segment 223. The vertical cross-section of first ring-shaped segment 221 is two symmetrical straight lines, the vertical cross-section of second segment 222 is two symmetrical curves with larger gradient upwards, and the vertical cross-section of third segment 223 is two symmetrical curves with smaller gradient and approaching to flat surface. Ring-shaped guiding surface 22 is not limited to the details described thereof, and the number of the segments and the structure of ring-shaped guiding surface 22 can be designed to meet the requirements of the wind turbine rotor used with the VAWT.

Furthermore, guiding unit 20 includes a ring wall 23 close to the center. Ring wall 23 has an axis hole 24 for installing an axis 30. When apparatus 100 of the present invention is assembled with the wind turbine rotor of VWAT, apparatus 100 shares axis 30 with the wind turbine rotor. In the present embodiment, the bottom view of guiding unit 20 has the same shape as the shape of inside ring-shape guiding surface 22, but is not limited to the details described thereof. The shape of guiding unit 20 can be designed to meet the requirements of the wind turbine rotor used with the VAWT.

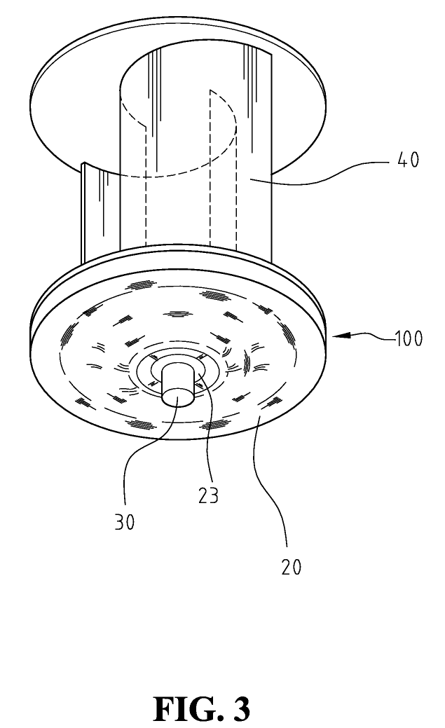

FIG. 3 shows a three-dimensional schematic view of the apparatus of the present invention applied to the first type of wind turbine rotor. Wind turbine rotor 40 in this embodiment shows a type of wind turbine rotor commonly found in conventional VAWT. Any other types of wind turbine rotor of VAWT can also be used in this present embodiment to operate with apparatus 100 of the present invention. In this embodiment, apparatus 100 is engaged to the bottom of wind turbine rotor 40, and the bottom of axis 30 is connected to generator (not shown in the figure). When wind turbine rotor 40 is driven by the moving air, i.e., wind, and starts to rotate, apparatus 100 also starts to rotate synchronously. Because ball units 10 are initially located close to the center of apparatus 100, the system has the minimum rotational inertia; therefore, the VAWT can be started by lower wind speed. As the rotation speed increases, because of the centripetal force, ball units 10 of apparatus 100 roll from center of apparatus 100 outwards to the brink of circumference of apparatus 100; therefore, the overall rotational inertia of the wind turbine rotor system increases so as to stabilize and maintain the rotation speed of the wind turbine rotor and reduce or eliminate the vibration caused by turbulence during wind turbine rotor rotation.

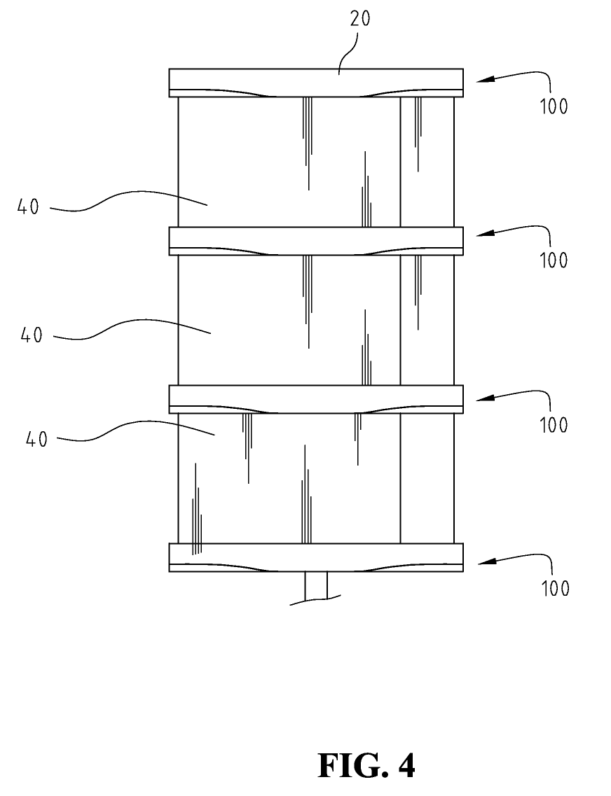

FIG. 4 shows a schematic view of the present invention in the second actual application. In this embodiment, wind turbine rotor 40 is the same as the wind turbine rotor of FIG. 3. However, there are four stabilizing apparatuses 100 and three wind turbine rotors in this embodiment. Apparatuses 100 and wind turbine rotors 40 are stacked in an interleaved manner. Therefore, apparatus 100 of the present invention can be installed at the top location or the bottom location of wind turbine rotor 40, or even installed between two wind turbine rotors. In addition, apparatus 100 of the present invention can be also installed on the shaft between the top and the bottom of the wind turbine rotor.

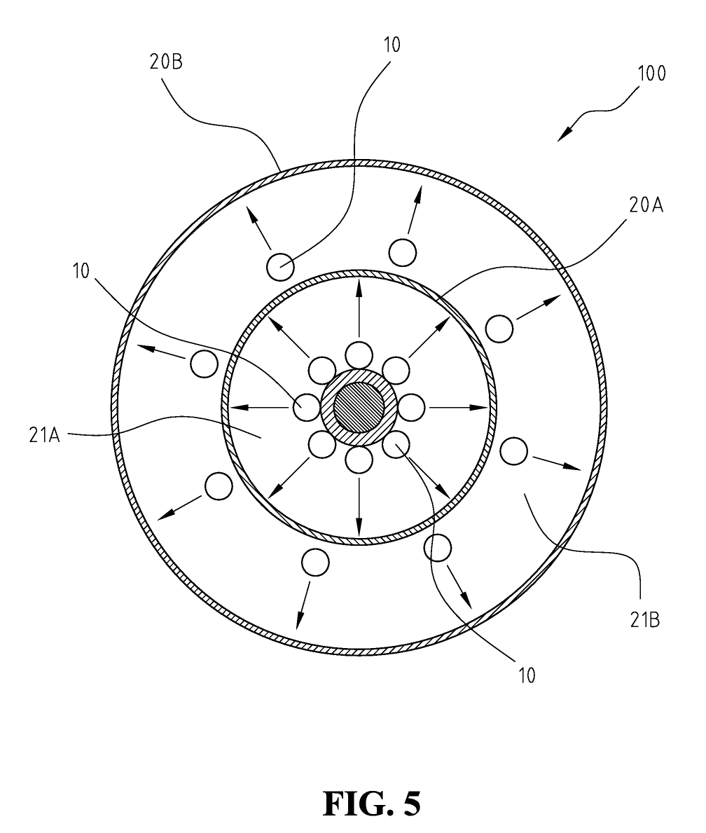

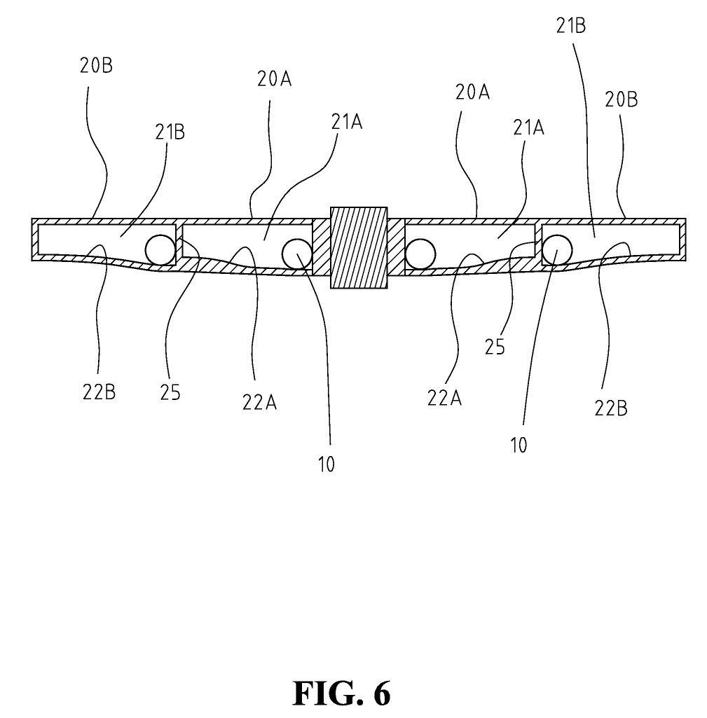

The above embodiment with actual applications shows the apparatus of the present invention with a single guiding unit. However, the present invention can also include two or more guiding units in the design, as shown in the following embodiment. FIGS. 5 and 6 show a lateral cross-sectional view and a vertical cross-sectional view of the second embodiment of the present invention. The present embodiment includes two guiding units 20. As shown in FIGS. 5 and 6, apparatus 100 includes at least four ball units 10, a first guiding unit 20A and a second guiding unit 20B. First guiding unit 20A and second guiding unit 20B are concentric rings, with first guiding unit 20A as the inner ring and second guiding unit 20B as the outer ring. The two neighboring guiding units are separated by a ring wall 25. Both first guiding unit 20A and second guiding unit 20B have at least two ball units 10 inside. Also, first guiding unit 20A and second guiding unit 20B form independent ring-shaped housing space 21A, 21B and ring-shaped guiding surfaces 22A, 22B. In the present embodiment, ring-shaped guiding surface 22A and ring-shaped guiding surface 22B are not necessarily the same. Instead, ring-shaped guiding surface 22A and ring-shaped guiding surface 22B can be designed to meet the requirements in the applications.

In summary, when a plurality of guiding units are included, the plurality of guiding units can be engaged together as concentric rings, with the next guiding unit as the outer ring of the previous guiding unit. Each guiding unit forms an independent ring-shaped housing space with a ring-shaped guiding surface to house a plurality of ball units inside. In this manner, the overall structural strength of the apparatus is enhanced. Although the apparatus with a plurality of guiding units require a higher wind speed to start, the rotation inertia is also increased. Therefore, the apparatus with a plurality of guiding units is suitable for operation in an environment with stronger and yet unstable winds.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A stabilizing apparatus, applicable to wind turbine rotor of vertical axis wind turbine (VAWT), said stabilizing apparatus comprising:
a plurality of ball units; and
at least a guiding unit, having a circular cross-section and forming a ring-shaped housing space inside for housing said ball units, the inner wall of the bottom of said ring-shaped housing space inside said guiding unit forming a ring-shaped guiding surface, said ring-shaped guiding surface extending from the center of said apparatus towards the brink of the circumference of said apparatus, the straight line connecting the edge of the inner circle and the edge of the outer circle of said ring-shaped guiding surface forming an angle of 0-45° to the horizon surface, said ball units rolling along said ring-shaped guiding surfaces towards to brink of circumference of said apparatus because of centripetal force when said apparatus being rotated with said wind turbine rotor, the rotational inertia of said wind turbine rotor being changed as the distance between said ball units and the center of said stabilizing apparatus so as to achieve stabilizing rotation of said wind turbine rotor and easy starting said wind turbine rotor.

2. The apparatus as claimed in claim 1, wherein said ball units are balls having proper weight.

3. The apparatus as claimed in claim 1, wherein said ring-shaped guiding surface inside said guiding unit is a ring-shaped disk and forms an angle of 0 to the horizontal surface.

4. The apparatus as claimed in claim 1, wherein said ring-shaped guiding surface inside said guiding unit is an upside-down cone with a cross-sectional view of two symmetrical slant lines, each said slant line forms an angle of 0-45° to the horizontal surface.

5. The apparatus as claimed in claim 1, wherein said ring-shaped guiding surface inside said guiding unit is an upside-down cone with a cross-sectional view of two symmetrical curves, and each said symmetrical curve extends monotonically increasingly from the center of said apparatus towards the brink of said apparatus.

6. The apparatus as claimed in claim 1, wherein said ring-shaped guiding surface of said guiding unit further comprises a plurality of connected ring-shaped segments, with the cross-sectional view of each said ring-shaped segment being symmetrical straight lines, slant lines or curves.

7. The apparatus as claimed in claim 1, wherein said guiding unit includes a ring wall inside said guiding unit, and said ring wall is located at the center area of said guiding unit.

8. The apparatus as claimed in claim 1, wherein said guiding unit further includes an axis hole located at the center of said guiding unit.

9. The apparatus as claimed in claim 1, wherein when a plurality of guiding units is included, said plurality of guiding units are engaged together in a manner of concentric rings with next guiding unit positioned as an outer ring of a previous guiding unit, a ring wall exists between any two neighboring guiding units, each guiding unit forms a ring-shaped housing space and a ring-shaped guiding surface, and each said ring-shaped housing space of said guiding unit houses at least two said ball units.

10. The apparatus as claimed in claim 9, wherein said ring-shaped guiding surfaces of two neighboring guiding units are not necessarily the same.

11. The apparatus as claimed in claim 9, wherein said ring-shaped guiding surface inside said guiding unit is a ring-shaped disk forming an angle of 0 to the horizontal surface.

12. The apparatus as claimed in claim 9, wherein said ring-shaped guiding surface inside said guiding unit is an upside-down cone with a cross-sectional view of two symmetrical slant lines, each said slant line forms an angle of 0-45° to the horizontal surface.

13. The apparatus as claimed in claim 9, wherein said ring-shaped guiding surface inside said guiding unit is an upside-down cone with a cross-sectional view of two symmetrical curves, and each said symmetrical curve extends monotonically increasingly from the center of said apparatus towards the brink of said apparatus.

14. The apparatus as claimed in claim 9, wherein said ring-shaped guiding surface inside said guiding unit further comprises a plurality of connected ring-shaped segments, with the cross-sectional view of each said ring-shaped segment being symmetrical straight lines, slant lines or curves.
